(19) United States
(12) Patent Application Publication
(10) Pub. No.: US 2008/0309152 A1
(43) Pub. Date: Dec. 18, 2008

(54) WHEEL INCLUDING A RIM, A HUB, AND A DEVICE FOR COUPLING THE RIM TO THE HUB

(75) Inventors: Jean-Luc VEUX, Rumilly (FR); Antoine FELICIANO, Doussard (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 12/137,162

(22) Filed: Jun. 11, 2008

(30) Foreign Application Priority Data
Jun. 12, 2007 (FR) 07.04165

(51) Int. Cl. B60B 1/04

(52) U.S. Cl. 301/59

(57) ABSTRACT

A wheel including a rim, a hub, and at least one device for coupling the rim to the hub, the coupling device including a spoke associated with a first head, the hub defining a first groove for receiving a portion of the spoke in a plane perpendicular to the axis of the wheel, and, along a tangential direction with respect to the hub, the hub further defines an abutment along the tangential direction for supporting the head. The hub includes an arrangement for retaining the head along a radial direction, when the spoke is oriented tangentially with respect to the hub.

### CROSS-REFERENCE TO RELATED APPLICATION

This application claims priority under 35 U.S.C. §119 of French Patent Application No. 07 04165, filed on Jun. 12, 2007, the disclosure of which is hereby incorporated by reference thereto in its entirety.

### BACKGROUND OF THE INVENTION

1. Field of the Invention

The invention relates to wheels having a rim, a hub, and at least one device for coupling the rim to the hub, the coupling device including a spoke. The invention more particularly relates to a wheel equipped with spokes and a hub provided for the wheel, as well as a method for making such wheels.

Wheels and hubs of the aforementioned type are adapted to bicycles and other vehicles, such as wheelchairs, or the like.

2. Description of Background and Other Information

Conventionally, a wheel includes a rim, a hub, and at least one device for coupling the rim to the hub, such as a spoke. Such a spoke can be provided to have a first head associated therewith for fastening it to the hub. The hub can also be provided to have a groove for receiving a portion of the length of the spoke, in a plane perpendicular to the axis of the wheel, and along a tangential direction with respect to the hub. In addition, the hub further includes an abutment, along the tangential direction, on which the head is supported when the spoke is tensioned. When the wheel is mounted and adjusted, each spoke is tensioned in the resting state of the wheel, in the case of wheels having tensioned spokes. This retains the portion of the spoke length in the groove, and the head in contact with the tangential abutment. Consequently, each spoke exerts a tangential force on the hub, i.e., a force that is offset with respect to the axis of the wheel. The wheel can then be referred to as being tangentially mounted and the spoke pattern can be referred to as tangential.

An advantage resulting from this known mounting method is that it is possible to use a straight spoke having a coaxial head. For example, the spoke and the head can form a unitary element made of metal. This enables a transmission of the forces along the longitudinal direction of the spoke. In other words, there is no unwanted mechanical torque applied to the spoke, as would be the case, for example, with a metallic spoke having a bent end, or elbow.

However, a drawback has been observed with regard to certain tangentially mounted wheels, in which the hub has a groove and an abutment for receiving the spoke and its head.

Sometimes, the spoke head may be momentarily spaced apart from the abutment when an exceptional stress occurs, thereby causing the spoke to loosen completely, for example. This may result in the separation of the spoke and hub. In other words, the spoke head may detach from the hub.

It is to be understood that an exceptional stress occurs unusually, for example upon striking a stone, a curb, or encountering a pothole, or the like. A deformation of the rim then induces a decrease in the tension of the spoke, and sometimes a decrease that is sufficient to cause the head to detach.

### SUMMARY OF THE INVENTION

In view of the above, the invention is provided to prevent detachment of the head of a coupling device from a hub.

Further, the invention makes it easier to mount the wheel. Still further, the invention provides an improved spoke fastening device.

To this end, the invention provides for a wheel having a rim, a hub, and at least one device for coupling the rim to the hub, the coupling device including a spoke associated with a first head, the hub defining a first groove for receiving a portion of the spoke, in a plane perpendicular to the axis of the wheel and along a tangential direction with respect to the hub, the hub further defining an abutment along the tangential direction for supporting the head.

The hub of a wheel according to the invention further includes an arrangement to retain the head along a radial direction, when the spoke is oriented tangentially with respect to the hub.

Because it operates along a radial direction of the wheel, the retaining arrangement retains the coupling device against the abutment, or opposite the abutment, regardless of the tensioning state of the spoke. Given that the head is affixed to the spoke, the spoke portion involved remains in the groove. In practice, this means that the head remains attached to the hub and that the spoke therefore remains affixed to the hub. In other words, the spoke does not detach from the hub, regardless of the forces exerted on the wheel.

One of the resulting advantages is that the wheel, although subject to an exceptional stress, or force, is kept in good shape. The wheel is more reliable over time, and its need for maintenance is reduced. It is easier to mount the wheel because the head is retained, even when the spoke is not tensioned.

### BRIEF DESCRIPTION OF DRAWINGS

Other characteristics and advantages of the invention will be better understood from the description that follows, with reference to the annexed drawings showing, by way of non-limiting embodiments, how the invention can be made, and in which:

FIG. 1 is a perspective view of a wheel, according to a first embodiment of the invention;

FIG. 2 is a perspective view of a portion of the wheel of FIG. 1, more particularly showing the hub;

FIG. 3 is a longitudinal cross section of the hub of the wheel according to the first embodiment;

FIG. 4 is a perspective view of a portion of the hub defining a first groove and a second groove, with a spoke approaching the hub;

FIG. 5 is similar to FIG. 4, in the case in which the head of a first coupling device is radially inserted in the first groove;

FIG. 6 is similar to FIG. 4, in the case in which the head of a first retaining device is facing a first abutment, and in which a portion of the spoke is located in the first groove, along a tangential direction with respect to the hub;

FIG. 7 is similar to FIG. 6 and, compared thereto, further has a second coupling device in the area of the second groove;

FIG. 8 is a view similar to FIGS. 4 to 7, for a second embodiment of the invention;

FIG. 9 is a view similar to FIG. 8, for a third embodiment of the invention;

FIG. 10 is a view similar to FIG. 4, with two spokes approaching the hub, for a fourth embodiment of the invention;

FIG. 11 is a view similar to FIG. 5, for the fourth embodiment of the invention;

FIG. 12 is similar to FIG. 7, for the fourth embodiment of the invention.

### DETAILED DESCRIPTION OF THE INVENTION

Although the embodiments relate to a wheel adapted for a bicycle, it is to be understood that they also apply to wheels adapted for other vehicles, as mentioned above.

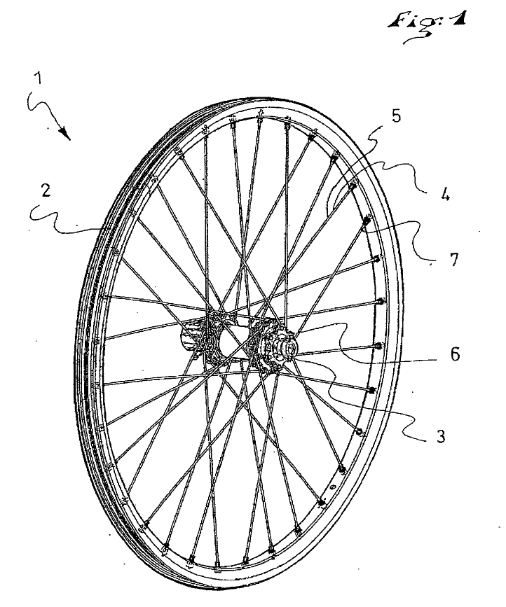

FIGS. 1 to 7 are directed to a first embodiment.

As shown in FIG. 1, a wheel 1 includes a rim 2, a hub 3, and devices 4 for coupling the rim 2 to the hub 3.

The rim 2, well known to one of ordinary skill in the art, is not described in detail. However, it should be noted that this rim 2 can have any profile, especially for receiving a tire or a tube. The rim can include, or be made from, any suitable material, such as metal or composite fibers associated with a binder.

Each coupling device 4 includes a spoke 5 that extends in a longitudinal direction L, between a first end 6, provided to be affixed to the hub 3, and a second end 7, provided to be affixed to the rim 2.

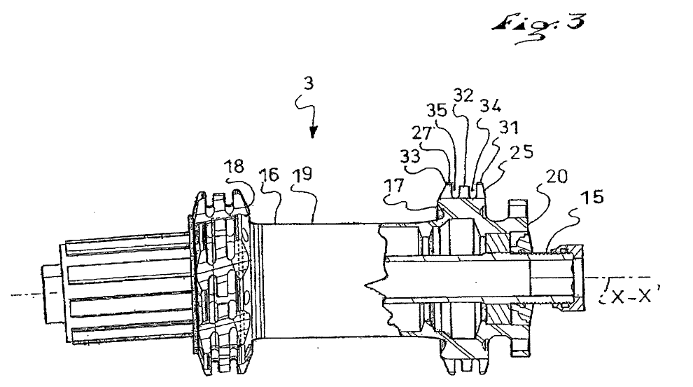

According to the first embodiment, as seen in FIG. 4, for example, the coupling device 4 includes a first head 8 affixed to the spoke 5 and is constituted in this case by a coaxial widening of the spoke. For example, the head 8 and the spoke 5 form a unitary element, which can be made from a metallic alloy including steel, aluminum, or the like. The head 8 can be formed by stamping, or swaging, the spoke 8 in a direction toward the first end 6. This enables the coupling device to be made at low cost.

The head could alternatively be attached to the spoke, or other materials could be used. In the latter case, a spoke including synthetic fibers is suitable.

According to the first embodiment described, the spoke 5 as well as the head 8 have circular cross sections. These characteristics provide the spoke with a conventional appearance and calls for economical manufacturing techniques. For example, the spoke can be obtained by wire drawing.

Alternatively, however, the spoke 5 and/or the head 8 can be provided to have any appropriate cross section or shape. For example, the spoke can have a rectangular cross section, an oblong cross section, or the like. A substantially tapered cross section can provide the spoke 5 with aerodynamic properties.

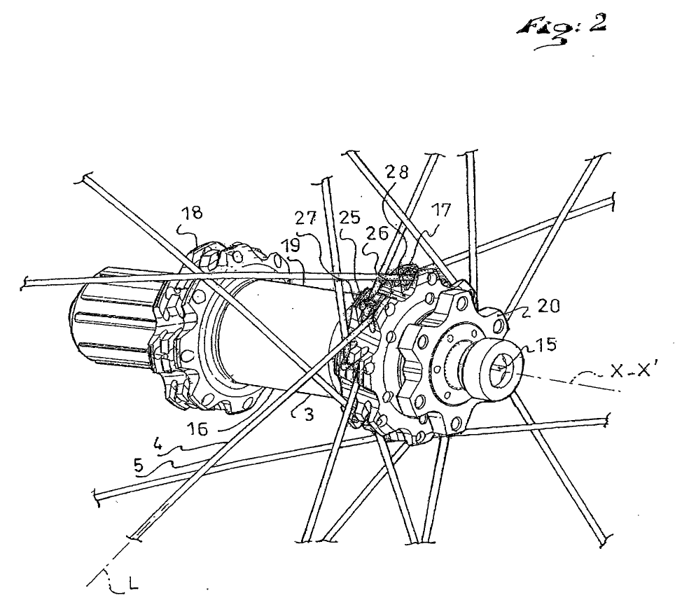

The hub 3 is shown in more detail by means of FIGS. 2 and 3.

Conventionally, the hub 3 includes a shaft 15 having an axis X-X′, which is provided to guide the body 16 rotationally. The axis X-X′ of the shaft 15 also constitutes the axis of the hub 3 and the axis of the wheel 1. The shaft 15 is adapted to be removably affixed to a support such as the fork or the frame of a bicycle. For example, the body 16 of the hub includes a first flange 17 and a second flange 18 connected to one another by a barrel 19. The flanges 17, 18 are provided to retain the ends 6 of the spokes 5. More specifically, as will be described in more detail hereinafter, the first flange 17 retains a first set of spokes, and the second flange 18 retains a second set of spokes.

According to the first embodiment of the invention, a disk-carrying plate 20 is also provided. The plate 20 is adapted to support a brake disk (not shown). This arrangement is known to one with ordinary skill in the art and is not described further.

To facilitate the manufacture of the body 16 of the hub, the flanges 17, 18, 20 and the barrel 19 form a unitary element. However, one could provide, for example, to assemble one or more of the flanges to the barrel.

The body 16 is rotationally guided about the shaft 15 by any appropriate means, such as by means of roller bearings, ball bearings, slide bearings, joints, or any useful element or assembly of elements.

To retain the spokes 5, each of the first 17 and second 18 flanges is structured as explained hereinafter. For convenience, the explanations are provided for a single flange, namely the first flange 17. However, the second flange 18 can constructed in the same way. Moreover, in the illustrated embodiment, the second flange is constructed the same way.

Generally speaking, the first flange 17 includes alternating fingers 25 and notches 26 that are circularly distributed in a plane perpendicular to the axis X-X′. Each finger is an extension of the flange 17 and is oriented radially, in a direction extending away from the axis X-X′. Consequently, a notch 26 separates two successive fingers. The notches 26 lighten the flange 17 and, thereby, the hub 3.

According to the first embodiment, and in a non-limiting manner, the fingers 25 and notches 26 have substantially the same structure and, in particular, the same radial dimensions. This means that each top 27 of a finger 25, or that each bottom 28 of a notch 26, is at the same distance from the axis X-X′. This makes it easier to balance the hub 3 rotationally.

To improve the balancing further, the fingers 25 and notches 26 are evenly distributed on the periphery of the first flange 17.

By way of a non-limiting example, a flange 17 has seven fingers 25 and seven notches 26. Each finger 25 bears two ends 6 of two spokes 5. In total, a flange 17 bears a set of fourteen spokes 5, and the wheel 1 includes twenty eight spokes. This non-limiting number offers a good compromise between mechanical strength and the weight of the wheel. The number of spokes could be more or less than fourteen.

Along the axial direction X-X′, each finger includes a first wing 31, a second wing 32, and a third wing 33. In a broader sense, each flange, and therefore the hub, includes three parallel collars each defining the wings 31, 32, 33 of the fingers 25, these collars being axially separated by peripheral grooves 34, 35.

Due to the configuration of the flanges 17, 18, the hub 3 therefore defines the first 34 and second 35 grooves, for receiving portions of the spoke 5, in a plane perpendicular to the axis X-X′ of the wheel 1, and along a tangential direction with respect to the hub.

It will be seen hereinafter, by means of FIGS. 4 to 7, that the hub 3 further defines abutments 41, 42 in the area of the flanges for supporting heads 8 of the coupling devices 4, whether the spokes 5 are tensioned or not tensioned.

According to the invention, the hub of the wheel 1 includes an arrangement for retaining the head 8 along a radial direction, when the spoke 5 is tangentially oriented with respect to the hub 3.

This retaining arrangement retains the head 8 with respect to the flange 17 along a radial direction. In other words, the retaining arrangement prevents the head 8 from moving radially in a direction away from the axis X-X′. Consequently, the spoke 5 remains in place in the groove 34, even if it is not tensioned. This makes it easier to mount the wheel 1, as will be seen better hereinafter. This also prevents an untimely detachment of a spoke 5 with respect to the hub, particularly when the bicycle is being ridden, for example, and an impact is made on the wheel 1, such as from a pothole or otherwise.

As can be seen in FIG. 4, for example, the first wing 31 is generally tooth-shaped, with a substantially flat top 50. The first wing 31 extends lengthwise along a tangential direction of the first flange 17, from a first end 51 to a second end 52. The top 50 connects the ends 51, 52 to one another. Each end 51, 52 of the wing 31 partially demarcates a notch 26. The notches 26 extend axially along the entire thickness of each collar. Thus, the wing 31 is a circular section of a collar of the first flange 17. The wing 31 extends depthwise along the direction X-X′, between two opposite surfaces 53, 54.

The second 32 and third 33 wings can be characterized the same way as the first wing. Thus, the second wing 32 has a top 60, a first end 61, a second end 62, and two opposite surfaces 63, 64. The third wing 33 has a top 70, a first end 71, a second end 72, and two opposite surfaces 73, 74.

In the end, the three wings 31, 32, 33 are parallel with respect to one another, and are each oriented in a plane perpendicular to the axis X-X′. The first ends 51, 61, 71 of the wings are aligned along the axis X-X′. The second ends 52, 62, 72 of the wings are aligned along the axis X-X′. Finally, the tops 50, 60, 70 are aligned along the axis X-X′.

According to the first embodiment described, and in a non-limiting manner, the first 41 and second 42 abutments are obtained by boring the wings 31, 32, 33 depthwise. As a result, the first wing 31 has a hole 81 between its surfaces 53, 54. Similarly, the second wing 32 has a hole 82 between its surfaces 63, 64, and the third wing 33 has a hole 83 between its surfaces 73, 74. These holes 81, 82, 83, which are through holes, define support surfaces for the heads 8 of the spokes 5. In other words, the first through hole 81 of the first wing 31 forms the abutment 41 for supporting the head 8 when the spoke 5 is tensioned. It will be seen better hereinafter that the hole 81 serves as an abutment in both a tangential direction and a radial direction. This enables the hub 3 to provide a double, tangential, and radial abutment. Similarly, the second through hole 82 of the second wing 32 forms the abutment 41 and/or the abutment 42, and the third through hole 83 forms the abutment 42. Here again, the third hole 83 serves as an abutment in both a tangential direction and a radial direction.

In order to simplify the manufacture of the hub 3, the three holes 81, 82, 83 are made by boring along the axis P-P′ with a drill, for example. As a result, the holes 81, 82, 83 are circular and extend through the wings. However, other shapes are suitable. For example, the holes can be provided such that they do not extend completely through the wings, i.e., they can be blind holes.

According to the first embodiment, the holes 81, 82, 83 are coaxial, i.e., aligned with respect to one another. However, they can be oriented alone an axis P-P′ that is offset with respect to the axis X-X′, as explained hereinafter.

As a result, the hole 81 of the first wing 31 is close to the first end 51, while the hole 83 of the third wing 33 is close to the second end 72. Consequently, the hole 82 of the second wing 32 is substantially halfway between the ends 61, 62.

Still according to the first embodiment, the top 50 of the first wing 31 continuously connects the ends 51, 52. Similarly, the top 70 of the third wing 33 continuously connects the ends 71, 72. Conversely, the top 60 of the second wing 32 is discontinuous. A first passage 84 opens the top 60 toward the hole 82 of the second wing 32. This passage 84 is made by any known technique, such as by milling, or the like. The passage 84 makes it possible to reversibly affix one or several spokes 5 to a finger 25, as chronologically explained hereafter by means of FIGS. 4 to 7.

As seen initially in FIG. 4, a coupling device 4 is positioned in the area of the hub 3. Thus, a spoke 5 associated with a head 8 is brought close to the first groove 34, in a plane perpendicular to the axis X-X′, and along a radial direction. This means that the longitudinal direction L of the spoke 5 substantially crosses the axis X-X′. The spoke 5 is arranged so that the head 8 is located above the first groove 34, level with the passage 84.

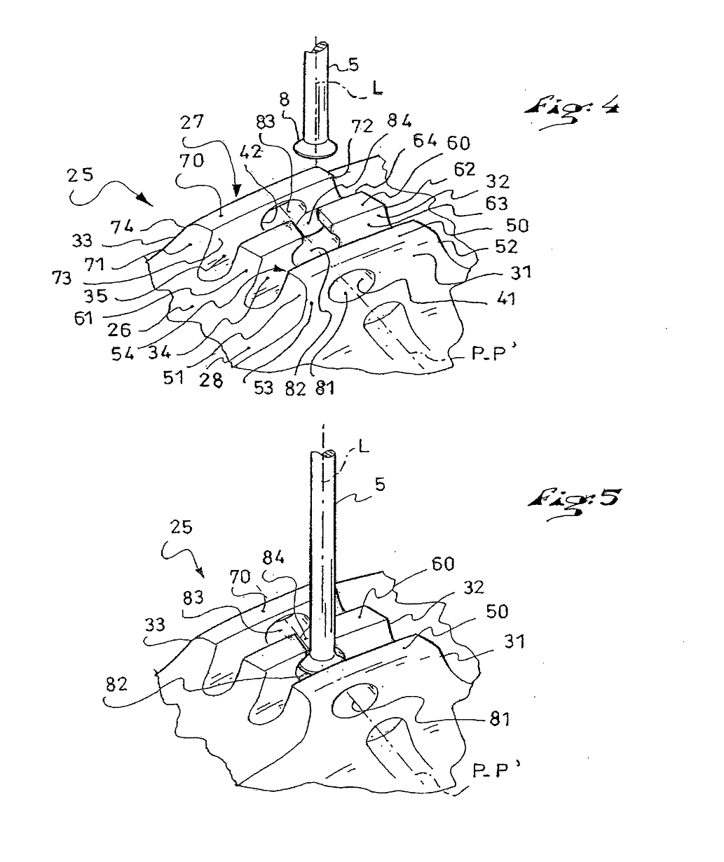

Next, as shown in FIG. 5, the spoke 5 is radially displaced toward the hub 3 in order to have the head 8 inserted in the groove 34 and in the first 81 and second 82 holes. This is possible because the passage 84 locally widens the first groove 34.

Finally, as seen in FIG. 6, the spoke 5 is tilted in the groove 34 so as to take a tangential direction with respect to the hub 3. In this case, a portion of the spoke 5 is maintained along the axis X-X′ by the wings 31, 32. The head 8 is retained against a portion of one or both holes 81, 82 when the spoke 5 is tensioned. Thus, the holes 81, 82 constitute the first abutment 41 in the tangential direction that enables the spoke 5 to be tensioned.

Moreover, consistent with the spirit of the invention, the top 50 of the wing 31 radially retains the head 8 when the spoke 5 is tilted in the groove 34. Indeed, the width of the groove 34 is equal to or slightly greater than the diameter of the spoke. For example, the groove width values and the spoke diameter values on the order of 2 mm are suitable. The diameter of the head 8 is substantially greater than that of the spoke. A head diameter on the order of 4 mm is suitable. Consequently, the passage 84 extends over several millimeters, i.e., over at least 2 mm.

Consequently, the head 8 takes support on the top 50 if it is radially stressed in a direction extending away from the axis X-X′. This means that when the wheel 1 is mounted, the first ends 6 of the spokes 5 can no longer leave the hub in an untimely, or inopportune, manner.

To summarize the first embodiment of the invention, the arrangement to retain the head 8 in a radial direction includes the continuous top 50 of a wing 31, in the location where it extends around the first hole 81, which defines the abutment 41 for supporting the head when the spoke 5 is tensioned. In other words, each hole 81, 83 defines a double, radial, and tangential abutment. The abutments are on the outer wings of the three.

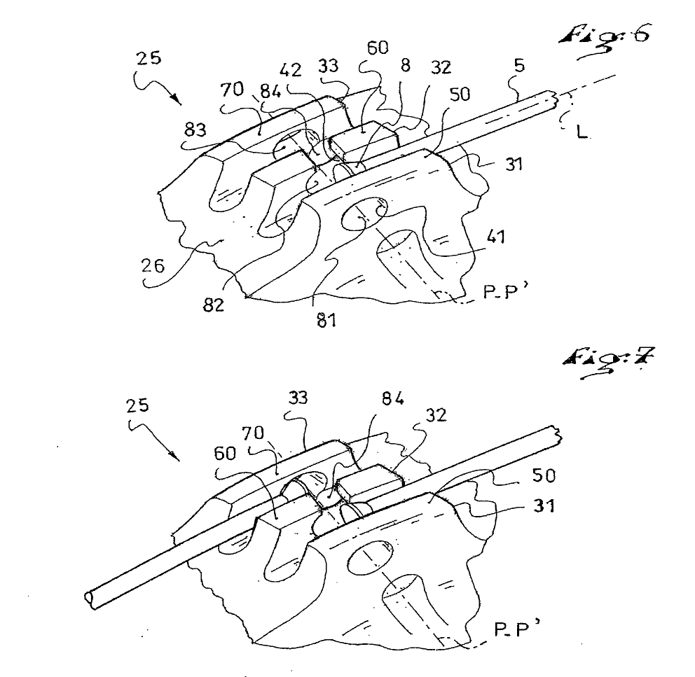

Still according to the first embodiment of the invention, as seen in FIG. 7, a second spoke 5 is housed and retained in the second groove 35. For the purpose of balancing tensions in the wheel 1, the spokes retained on the same finger 25 are oriented in two substantially opposite directions.

The second mounting is not described in further detail, because it is identical to the first.

It is noted, for example in the area of the first wing 31, that the distance that separates the first hole 81 from the second end 52 is greater than the distance between the hole 81 and the first end 51. This reinforces the mechanical strength of the wing 31 in opposing the traction of a spoke. Given that the axis P-P′ of the holes 81, 82, 83 of the wings is offset, as mentioned above, the same technical effect is obtained for the second spoke in the area of the third wing 33. In other words, the first 81 and third 83 holes are respectively located on the side of the end of the wing that is opposite the direction of traction.

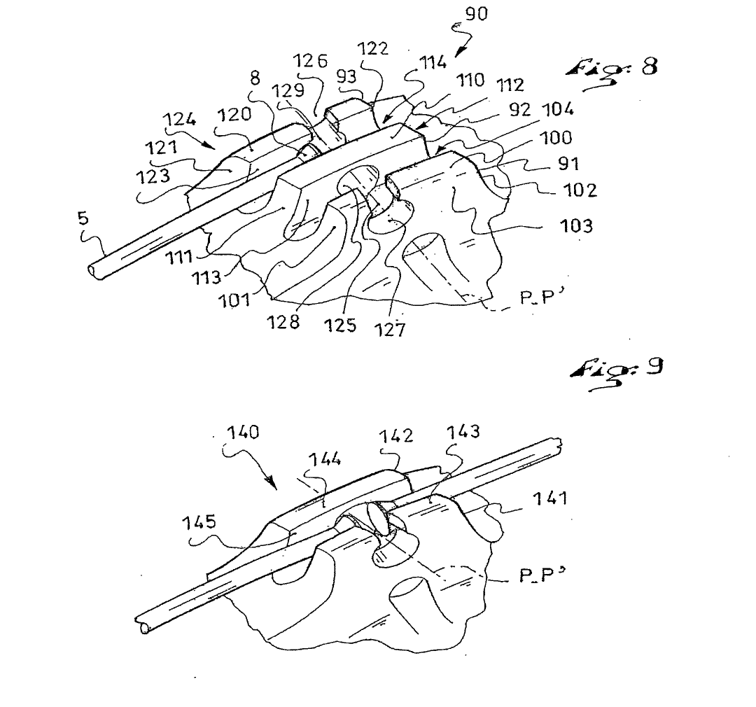

The other embodiments of the invention are shown hereinafter by means of FIGS. 8 to 12. For convenience, only the differences with respect to the first embodiment are shown.

For the second embodiment, as seen in FIG. 8, there is a finger 90 with three successive wings 91, 92, 93.

The first wing 91 has a discontinuous top 100, a first end 101, a second end 102, and two surfaces 103, 104. The second wing 92 has a continuous top 110, a first end 111, a second end 112, and two surfaces 113, 114. The third wing 93 has a discontinuous top 120, a first end 121, a second end 122, and two surfaces 123, 124.

The specific characteristic of the second embodiment is that it includes three wings 91, 92, 93, the central wing 92 of which has a continuous top, and the two end wings 92, 93 of which each have a discontinuous top. Consequently, two passages 125, 126 are arranged in the first 91 and third 93 wings to allow access to holes 127, 128, 129 that are formed successively in the wings. In other words, the radial abutment is on the central wing and the passages are on the outer wings. The spokes are affixed to the finger 90 as for the first embodiment.

The third embodiment is described hereinafter with reference to FIG. 9. In this case, a finger 140 only bears two wings 141, 142. The wing 141 has a discontinuous top 143, whereas the wing 142 has a continuous top 144. According to this embodiment, the single groove 145 between the two wings 141, 142 receives two heads 8 for two spokes 5, these spokes being oriented along opposite directions.

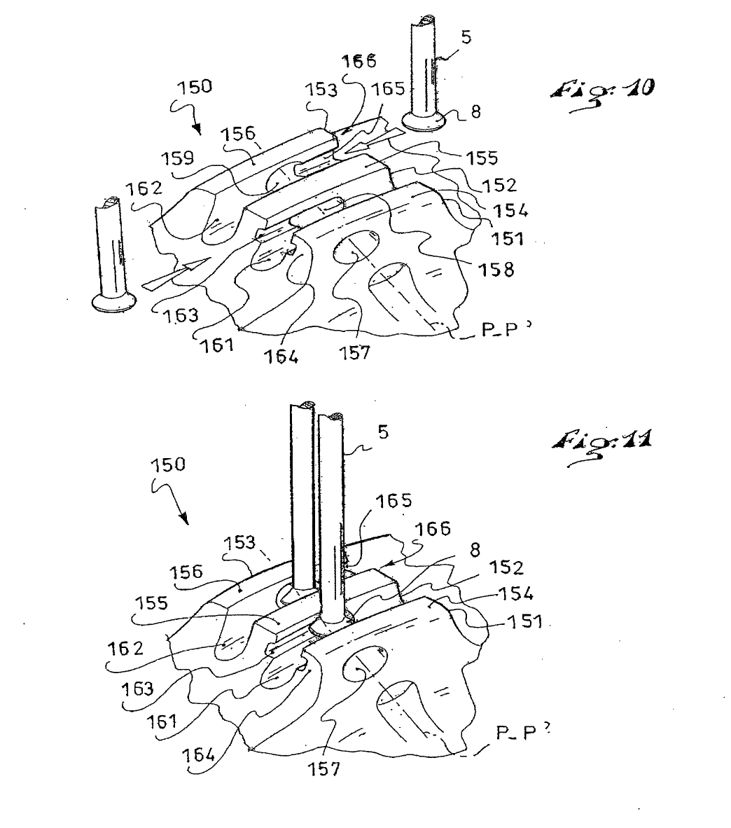

The fourth embodiment is described with reference to FIGS. 10 to 12. In this case, a finger 150 bears three wings 151, 152, 153, each having a continuous top 154, 155, 156, respectively. The wings are bored transversely by holes 157, 158, 159, respectively. The holes 157, 158, 159 define abutments for supporting heads 8 when spokes 5 are tensioned. The continuous tops 154, 155, 156 constitute an arrangement to retain the heads 8 along a radial direction of the hub.

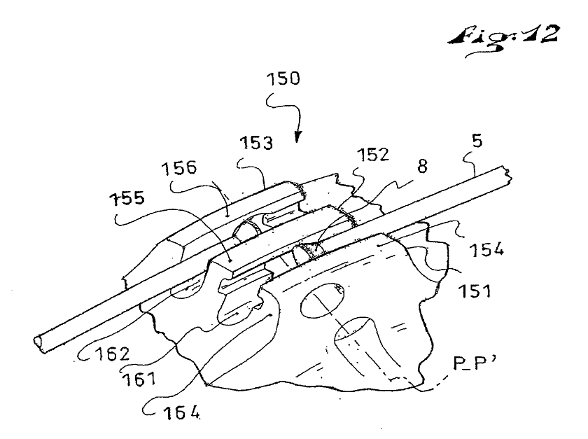

A specific characteristic of the fourth embodiment of the invention is the positioning of the heads 8 in the first 161 and second 162 grooves that are demarcated between the wings. Thus, the first groove 161 has a widening 163, from an end 164 to the holes 157, 158. The second groove 162 has a widening 165, from an end 166 to the holes 158, 159. Each widening is provided to allow the head 8 to slide in toward the holes. When the head 8 is being displaced, each spoke 5 is slidably engaged along the tangential direction by being radially erected to project with respect to the groove 161, 162, as seen in FIG. 11. Next, when the heads 8 are level with the holes 157, 158, 159, it suffices to tilt the spokes 5 back in the grooves 161, 162, according to FIG. 12, in order for them to connect the rim to the hub.

Generally speaking, the invention is made from materials and according to implementation techniques known to one with ordinary skill in the art.

The invention is not limited to the particular embodiments shown and described, and it encompasses all of the technical equivalents that fall within the scope of the claims that follow.

In particular, the holes that traverse the wings can have various shapes, including elongated shapes.

A spoke with its head can be brought close to a groove along a direction that is inclined up to 45%, in a plane perpendicular to the axis X-X′.

The notches between the fingers may be non-hollow, i.e., the collars may be solid. In such a case, the periphery of a flange has at least one continuous, circular groove between two collars, in the manner of a pulley.

All that has been described for one flange 17, 18 applies to the other flange. Thus, each flange 17, 18 includes a double abutment and a structure for engaging the spoke.

Generally speaking, the hub 3 includes at least two wings 31, 32, 33, 91, 92, 93, 141, 142, 151, 152, 153, a wing defining a double abutment, another wing defining a structure for engaging the spoke and a tangential abutment.

The hub 3 often includes three wings, means for engaging the spoke being defined by the central wing or by one or two outer wings.

1. A wheel comprising:
a rim;
a hub;
at least one device for coupling the rim to the hub, the coupling device comprising a spoke having a first head;
the hub defining a first groove for receiving a portion of the spoke in a plane perpendicular to a rotational axis of the wheel and along a tangential direction with respect to the hub;
the hub further defining an abutment along the tangential direction for supporting the head of the spoke;
the hub further comprising an arrangement to retain the head of the spoke along a radial direction when the spoke is oriented tangentially with respect to the hub.

2. A wheel according to claim 1, wherein:
the hub includes a double, tangential and radial, abutment.

3. A wheel according to claim 1, wherein:
the hub includes a pair of spaced-apart flanges, each of the flanges including a double abutment and a structure for engaging the spoke.

4. A wheel according to claim 1, wherein:
the hub includes a wing defining a double abutment, and another wing defining a structure for engaging the spoke and a tangential abutment.

5. A wheel according to claim 1, wherein:
the hub includes three wings, said three wings including a central wing and two outer wings;
an arrangement for engaging the spoke being defined by the central wing or by at least one of the two outer wings.

6. A wheel according to claim 1, wherein:
the hub includes a first wing and a second wing, a first groove being demarcated between the first wing and the second wing;
the first wing includes a first through hole forming an abutment and/or the second wing includes a second through hole forming an abutment;
the arrangement to retain the head of the spoke along the radial direction includes the continuous top of a wing in a location where the top extends around the hole defining the abutment.

7. A wheel according to claim 6, wherein:
the second wing includes a discontinuous top, a first passage opening the top toward the hole of the second wing.

8. A wheel according to claim 6, wherein:
the hub includes a third wing, a second groove being demarcated between the second wing and the third wing;
the second through hole of the second wing forming an abutment and/or a third through hole of the third wing forming an abutment.

9. A wheel according to claim 8, wherein:
the second wing includes a discontinuous top, a passage opening the top toward the hole of the second wing.

10. A wheel according to claim 8, wherein:
the first wing has a discontinuous top, the second wing has a continuous top, the third wing has a discontinuous top, two passages being arranged in the first and third wings to allow access to holes formed in the wings.

11. A wheel according to claim 6, wherein:
the first wing has a widening from one end to the holes.

12. A wheel according to claim 1, wherein:
the spoke has a circular cross section;
the head has a circular cross section.

13. A wheel according to claim 1, wherein:
the groove has a width equal to or slightly greater than a diameter of the spoke, the head of the spoke having a diameter substantially greater than the diameter of the spoke.

14. A wheel according to claim 6, wherein:
the hub includes a flange, the flange including alternating fingers and notches circularly distributed in a plane perpendicular to the rotational axis of the wheel, each wing being a radial extension of a finger.
